(19) United States
(12) Patent Application Publication
(10) Pub. No.: US 2004/0165143 A1
(43) Pub. Date: Aug. 26, 2004

(54) Eyeglasses with safety release strap

(76) Inventor: Mark Kleimeyer, Panama City Beach, FL (US)

Correspondence Address: MEHRMAN LAW OFFICE, P.C., ONE PREMIER PLAZA, 5605 GLENRIDGE DRIVE, STE. 795, ATLANTA, GA, 30342, US

(21) Appl. No.: 10/787,649

(22) Filed: Feb. 26, 2004

Related U.S. Application Data
(60) Provisional application No. 60/450,037, filed on Feb. 26, 2003.

(51) Int. Cl. G02C 1/00; G02C 5/00

(52) U.S. Cl. 351/142

(57) ABSTRACT

Eyeglasses including an eyeglasses body and a strap with a safety release device, such as a VELCRO™ connector. The safety release device may include a first connector element attached to the eyeglasses body and a second connector element attached to the strap. The eyeglasses may also include a length adjustment device. For example, the length adjustment device may loop through a eyelet integral with the eyeglasses body. More specifically, the strap may include a first end carrying the safety release device and a second end carrying the length adjustment device.

### REFERENCE TO RELATED APPLICATION

This application claims priority to commonly owned U.S. Provisional Application No. 60/450,037 filed on Feb. 26, 2003.

### TECHNICAL FIELD

This invention relates to eyeglasses and, more particularly, relates to eyeglasses with a safety release strap suitable for use as sunglasses for children.

### BACKGROUND

Eyeglasses in general are very popular, as are sunglasses for children. These eyeglasses often come with a strap that connects to the rear of the eyeglasses body to minimize the chance for losing the glasses. The strap allows the eyeglasses to be removed from the eyes and hang around the neck, which is a nice convenience. However, the strap can create a choking hazard, particularly for children and people working near machinery, such as amusement rides. This is a particularly high risk for very small children, such as a one or two year old, who may have an older sibling such as a three or four year old. In the course of horse play or a tantrum fueled by sibling rivalry, the older child may attempt to forcefully remove the glasses from the smaller child, and unwittingly choke the smaller child in the process. A similar choking hazard can occur if the child falls while snagging the strap on a restraint, or if the eyeglasses or strap becomes captured on a moving object, such as a piece of machinery, such as an amusement park ride.

### SUMMARY OF THE INVENTION

The present invention solves the problem of a choking hazard caused by eyeglasses with a strap by providing a strap with a safety release device. Generally described, the invention may be embodied in eyeglasses including an eyeglasses body and a strap connected to the eyeglasses body and having a safety release device. The strap (which may also be described as a lash, leash, band, cord, chain or lanyard) may also include a length adjustment device. More specifically, the strap may include a first end carrying the safety release connector and a second end carrying the length adjustment device. In one particular example, the length adjustment device loops through an eyelet (which may also be described as a hole, opening, slot or passage) integral with the eyeglasses body, and the safety release connector includes a first connector element attached to the eyeglasses body and a second connector element attached to the band. For example, the hook-and-loop fastener known as VELCRO™ may be used to form the connector elements of the safety release device.

### BRIEF DESCRIPTION OF THE FIGURES

FIG. 1 is a perspective view of eyeglasses including a band with a safety release shown with the safety release in the closed position.

FIG. 2 is an alternate perspective view of th4e eyeglasses of FIG. 1 shown with the safety release in the open position.

### DETAILED DESCRIPTION OF THE PREFERRED EMBODIMENTS

As noted above, the invention solves the problem of the choking hazard caused by eyeglasses with a strap by replacing the conventional strap with a strap having a safety release. The safety release, which is typically a small VELCRO™ connector with one connector element attached to the eyeglasses body and a second connector element attached to the strap, is configured to open when an unusual amount of pressure is applied. That is, the safety release will not open during normal use of the eyeglasses, but will open when pulled unusually hard, for example when yanked by a child or caught on a piece of machinery. The other end of the strap typically includes a size adjustment device, which is typically a larger VELCRO™ connector that loops through an eyelet in the rear of one side of the body of the eyeglasses. The length adjustment device may alternative be located somewhere along the band rather than at the end of the band.

The length adjustment device and/or the safety release device may connect to any part of the eyeglasses body, such as the frame around the eyepieces or earpieces. For this reason, the term “eyeglasses body” refers to the frame of the glasses in a broad sense, and therefore includes the portion of the frame that holds the eyepieces, any hinged or fixed earpieces, and any other structure attached to or extending from the frame.

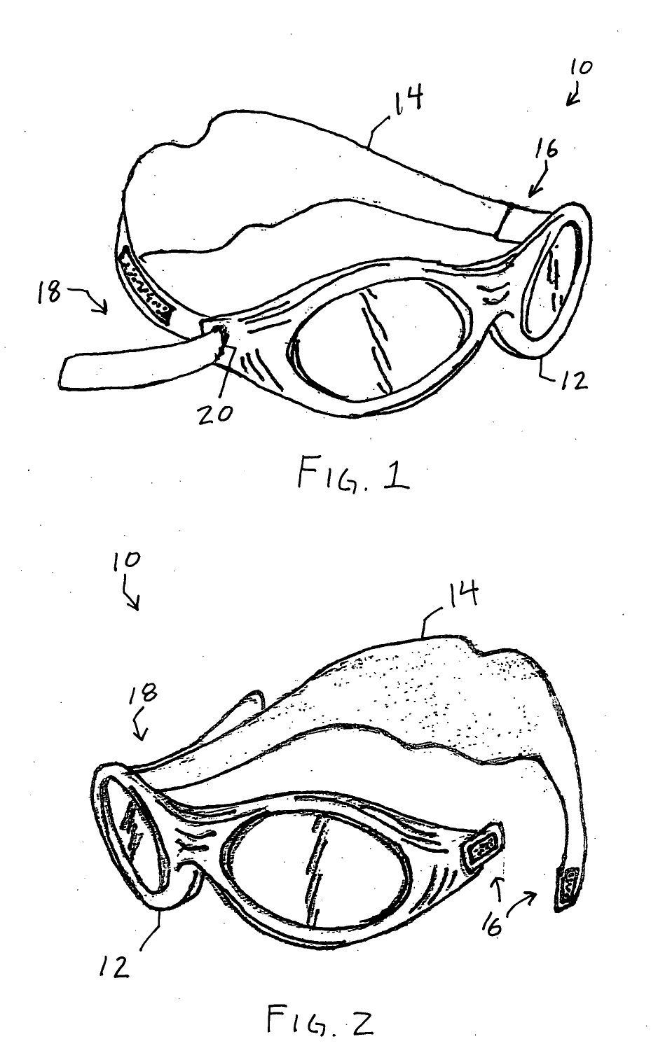

In addition, safety release devices other than a VELCRO™ connector may be used, such as a snap or other suitable type of releasable fastener. Nevertheless, it should be appreciated that a VELCRO™ connector is presently believed to be the most suitable type of connector for this particular application. Similarly, the invention may be embodied in any type of eyeglasses, such as children's eyeglasses, adult eyeglasses, reading glasses, prescription glasses, protective safety glasses, ski goggles, and so forth. It should be appreciated, however, that the invention is considered to be particularly well suited for children's sunglasses. The invention may also be practiced with any type of strap, such as a cord, chain, woven lanyard, or any other suitable strap. In particular, a fairly wide, flat band tapered at the ends formed from a flexible yet strong and light weight material, such as neoprene, is well suited to serve as a the safety release strap for the present application. This particular type of strap is illustrated in FIGS. 1 and 2.

As shown in FIG. 1, the invention may be embodied in children's sunglasses 10 that include an eyeglasses body 12 and strap 14 including a safety release 16. This safety release is shown in the closed position in FIG. 1. The safety release 16 typically includes a small hook-and-loop (i.e., VELCRO™) connector located at the connection between the glasses strap 14 and the eyeglasses body 12. The size of the VELCRO™ connector forming the safety release 16 is configured so that the connector remains closed during normal use of the eyeglasses, but opens when an unusual amount of pressure is applied. For example, the size of the VELCRO™ connector is selected such that the safety release 16 opens when the glasses are forcefully yanked by a small child. In particular, the VELCRO™ connector may be approximately one-half inch long and one-quarter inch high with the loop material (or the hook material) located on either side of the connector 16. The other end of the strap 14 includes a size adjustment connector 18, which is typically a longer (e.g., about two inches) VELCRO™ connector that loops through an eyelet 20 in the body of the eyeglasses.

Those skilled in the art will appreciate that the invention may be practiced with all types of glasses, including those with hinged earpieces and those without hinged earpieces, as shown in FIGS. 1 and 2. Similarly, the invention may be practiced with a wide variety of straps, safety release devices, and length adjustment devices so long as they are configured to serve the described safety release function.

The invention claimed is:

1. Eyeglasses with a safety release strap, comprising:
an eyeglasses body;
a strap connected to the eyeglasses body; and
a safety release device forming a releasable connection along the strap or between the eyeglasses body and the strap.

2. The eyeglasses of claim 1, wherein the strap further comprises a length adjustment device.

3. The eyeglasses of claim 1, wherein the safety release device includes a first connector element attached to the strap and a second connector element attached to the eyeglasses body.

4. The eyeglasses of claim 1, wherein the safety release device comprises a hook-and-loop fastener.

5. The eyeglasses of claim 1, wherein the strap comprises a thin, flat, flexible band.

6. The eyeglasses of claim 1, wherein the strap comprises neoprene.

7. Eyeglasses with a safety release device strap, comprising:
an eyeglasses body;
a strap connected to the eyeglasses body having a first end and a second end;
a safety release device associated with the first end of the band; and
a length adjustment device associated with the second end of the band.

8. The eyeglasses of claim 7, wherein the length adjustment device loops through a eyelet integral with the eyeglasses body.

9. The eyeglasses of claim 8, wherein the safety release device comprises a first connector element attached to the eyeglasses body and a second connector element attached to the band.

10. The eyeglasses of claim 9, wherein the safety release device comprises a hook-and-loop fastener.

11. The eyeglasses of claim 10, wherein the strap comprises a thin, flat, flexible band.

12. The eyeglasses of claim 11, wherein the strap comprises neoprene.
